(19) United States
(12) Patent Application Publication
(10) Pub. No.: US 2026/0304340 A1
(43) Pub. Date: Oct. 1, 2026

(54) COMPUTING RESOURCE AVAILABILITY REGISTRATION

(71) Applicant: QUALCOMM Incorporated, San Diego, CA (US)

(72) Inventors: Hua WANG, Basking Ridge, NJ (US); Qing LI, Princeton Junction, NJ (US); Navid ABEDINI, Basking Ridge, NJ (US); Sony AKKARAKARAN, Poway, CA (US); Mohamed Fouad Ahmed MARZBAN, San Diego, CA (US); Tao LUO, San Diego, CA (US); Junyi LI, Greentown, PA (US)

(21) Appl. No.: 19/542,450

(22) Filed: Feb. 17, 2026

Related U.S. Application Data
(60) Provisional application No. 63/781,934, filed on Apr. 1, 2025.

(51) Int. Cl. H04W 60/00; G06F 9/50

(52) U.S. Cl. CPC H04W 60/00; G06F 9/5005

(57) ABSTRACT

Various aspects of the present disclosure generally relate to wireless communication. In some aspects, a user equipment (UE) may transmit, during a registration procedure for establishing access to a radio access network, registration information to a network entity, wherein the registration information indicates one or more available computing resources and a computing service state associated with availability for performing one or more computing services. The UE may receive, from the network entity, a computing task request, associated with a computing task, in accordance with the available computing resources and the computing service state. Numerous other aspects are described.

### CROSS-REFERENCE TO RELATED APPLICATION

This Patent Application claims priority to U.S. Provisional Patent Application No. 63/781,934, filed on Apr. 1, 2025, entitled “COMPUTING RESOURCE AVAILABILITY REGISTRATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with computing resource availability registration.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

A wireless device that needs to access network resources may perform a registration process. For example, as part of registration process, a user equipment (UE) may transmit a registration request to a network entity, and the registration request may

include identification information and authentication credentials. Upon receipt of the request, the network entity may verify the information provided by the UE and, in response, may allocate a temporary identifier to the UE for managing subsequent communications. After the registration is completed, the UE may be permitted to access network services.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to transmit, during a registration procedure for establishing access to a radio access network (RAN), registration information to a network entity. The registration information may indicate one or more available computing resources and a computing service state associated with availability for performing one or more computing services. The processing system may be configured to cause the UE to receive, from the network entity, a computing task request, associated with a computing task, in accordance with the available computing resources and the computing service state.

Some aspects described herein relate to a network node. The network node may include a processing system. The processing system may include one or more processors and one or more code-storing memories coupled with the one or more processors. The processing system may be configured to cause the network node to receive, during a registration procedure for establishing access to a RAN, registration information output by a UE. The registration information may indicate one or more available computing resources of the UE and a computing service state associated with availability of the UE to perform one or more computing services. The processing system may be configured to cause the network node to transmit, to the UE, a computing task request, associated with a computing task, in accordance with the available computing resources and the computing service state.

Some aspects described herein relate to a method of wireless communication performed by a UE. The method may include transmitting, during a registration procedure for establishing access to a RAN, registration information to a network entity. The registration information may indicate one or more available computing resources and a computing service state associated with availability for performing one or more computing services. The method may include receiving, from the network entity, a computing task request, associated with a computing task, in accordance with the available computing resources and the computing service state.

Some aspects described herein relate to a method of wireless communication performed by a network node. The method may include receiving, during a registration procedure for establishing access to a RAN, registration information output by a UE. The registration information may indicate one or more available computing resources of the UE and a computing service state associated with availability of the UE to perform one or more computing services. The method may include transmitting, to the UE, a computing task request, associated with a computing task, in accordance with the available computing resources and the computing service state.

Some aspects described herein relate to a non-transitory computer-readable medium that stores a set of instructions for wireless communication by a UE. The set of instructions, when executed by one or more processors of the UE, may cause the UE to transmit, during a registration procedure for establishing access to a RAN, registration information to a network entity. The registration information may indicate one or more available computing resources and a computing service state associated with availability for performing one or more computing services. The set of instructions, when executed by one or more processors of the UE, may cause the UE to receive, from the network entity, a computing task request, associated with a computing task, in accordance with the available computing resources and the computing service state.

Some aspects described herein relate to a non-transitory computer-readable medium that stores a set of instructions for wireless communication by a network node. The set of instructions, when executed by one or more processors of the network node, may cause the network node to receive, during a registration procedure for establishing access to a RAN, registration information output by a UE. The registration information may indicate one or more available computing resources of the UE and a computing service state associated with availability of the UE to perform one or more computing services. The set of instructions, when executed by one or more processors of the network node, may cause the network node to transmit, to the UE, a computing task request, associated with a computing task, in accordance with the available computing resources and the computing service state.

Some aspects described herein relate to an apparatus for wireless communication. The apparatus may include means for transmitting, during a registration procedure for establishing access to a RAN, registration information to a network entity. The registration information may indicate one or more available computing resources and a computing service state associated with availability for performing one or more computing services. The apparatus may include means for receiving, from the network entity, a computing task request, associated with a computing task, in accordance with the available computing resources and the computing service state.

Some aspects described herein relate to an apparatus for wireless communication. The apparatus may include means for receiving, during a registration procedure for establishing access to a RAN, registration information output by a UE. The registration information may indicate one or more available computing resources of the UE and a computing service state associated with availability of the UE to perform one or more computing services. The apparatus may include means for transmitting, to the UE, a computing task request, associated with a computing task, in accordance with the available computing resources and the computing service state.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example associated with cooperative computing.

FIG. 3 is a diagram illustrating an example associated with device cooperation for distributed computing.

FIG. 4 is a diagram illustrating an example associated with radio access network-based user equipment (UE) computing registration.

FIG. 5 is a diagram illustrating an example process performed, for example, at a UE or an apparatus of a UE.

FIG. 6 is a diagram illustrating an example process performed, for example, at a network node or an apparatus of a network node.

FIGS. 7-8 are diagrams of example apparatuses for wireless communication.

### DETAILED DESCRIPTION

Distributed computing refers to a computational framework in which processing tasks and data handling operations may be distributed across multiple network nodes. Distributed computing may involve scenarios where a user equipment (UE) is configured to perform one or more computing operations that are traditionally executed by one or more network entities. This arrangement enables the UE to execute functions related to data processing, control signaling, or network management, thereby alleviating the processing burden on network core elements and facilitating more efficient use of system resources. The network, however, may not be aware of the UE’s computing resources (e.g., hardware or software capabilities for performing computing tasks) or availability of the UE’s computing resources for performing computing tasks.

When a UE seeks to join a network, the UE may perform a registration process. Examples of the registration process may include an initial registration (e.g., a registration process that the UE may perform when the UE is powered on), a mobility registration update (e.g., a registration process that the UE may perform when the UE moves to a new tracking area), or a periodic registration update (e.g., a registration process that the UE may perform periodically in accordance with a configuration). The registration process may include the UE transmitting a registration request message to a network node. The network node may select an appropriate access and mobility function (AMF) for the UE in response to the network node receiving the registration request message from the UE.

Various aspects relate generally to a registration process. Some aspects more specifically relate to a registration process for a UE participating in a distributed computing environment. In some aspects, a UE may, as part of a registration process, provide a network entity with information about available computing resources of the UE, a computing service state, or a combination thereof, among other examples. The computing service state may be associated with the UE’s ability to perform one or more computing services.

Particular aspects of the subject matter described in this disclosure can be implemented to realize one or more of the following potential advantages. In some examples, the described techniques can be used to efficiently manage UEs in a distributed computing environment. For example, when the UE provides, to the network, registration information associated with the UE’s available computing resources and computing service state, the network can determine which UEs are best-suited for performing computing services. Network performance may be improved by having the most-capable UEs perform computing services on behalf of less-capable UEs.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

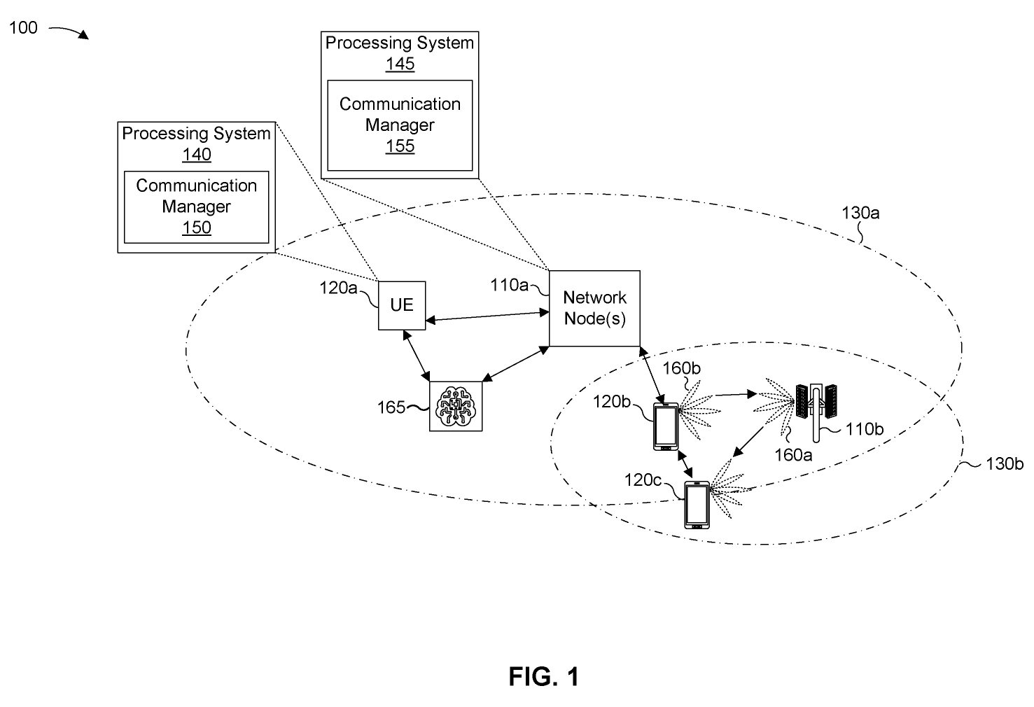

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110.

Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may transmit, during a registration procedure for establishing access to a RAN, registration information to a network entity, wherein the registration information indicates one or more available computing resources and a computing service state associated with availability for performing one or more computing services; and receive, from the network entity, a computing task request, associated with a computing task, in accordance with the available computing resources and the computing service state. Additionally, or alternatively, the communication manager 150 may perform one or more other operations described herein.

In some aspects, the network node 110 may include a communication manager 155. As described in more detail elsewhere herein, the communication manager 155 may receive, during a registration procedure for establishing access to a RAN, registration information output by a UE, wherein the registration information indicates one or more available computing resources of the UE and a computing service state associated with availability of the UE to perform one or more computing services; and transmit, to the UE, a computing task request, associated with a computing task, in accordance with the available computing resources and the computing service state. Additionally, or alternatively, the communication manager 155 may perform one or more other operations described herein.

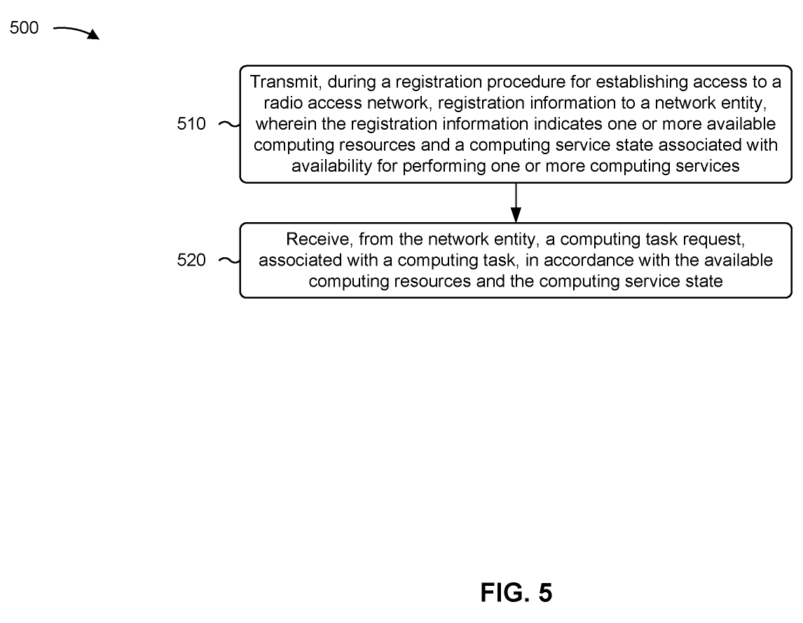

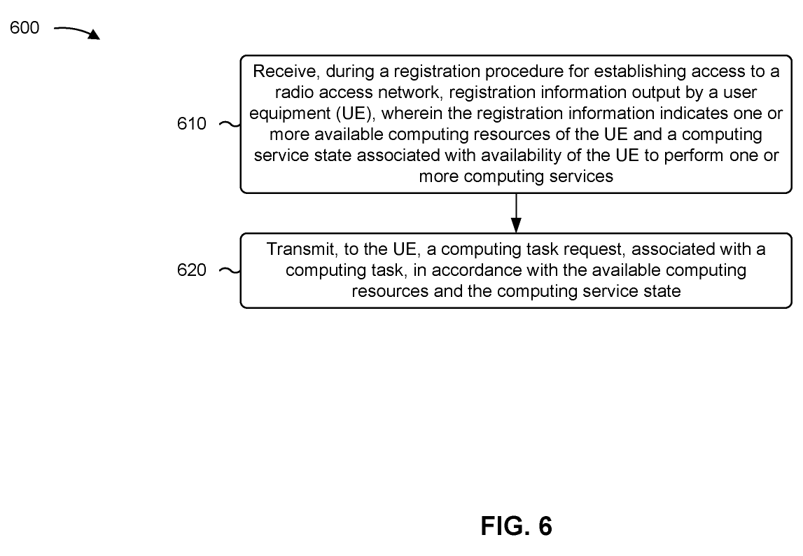

The network node 110, the processing system 145 of the network node 110, the UE 120, the processing system 140 of the UE 120, or any other component(s) of FIG. 1 may implement one or more techniques or perform one or more operations associated with registration information for cooperative computing, as described in more detail elsewhere herein. For example, the processing system 145 of the network node 110, or the processing system 140 of the UE 120 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 500 of FIG. 5, process 600 of FIG. 6, or other processes as described herein. In some examples, executing instructions may include running the instructions, converting the instructions, compiling the instructions, or interpreting the instructions, among other examples.

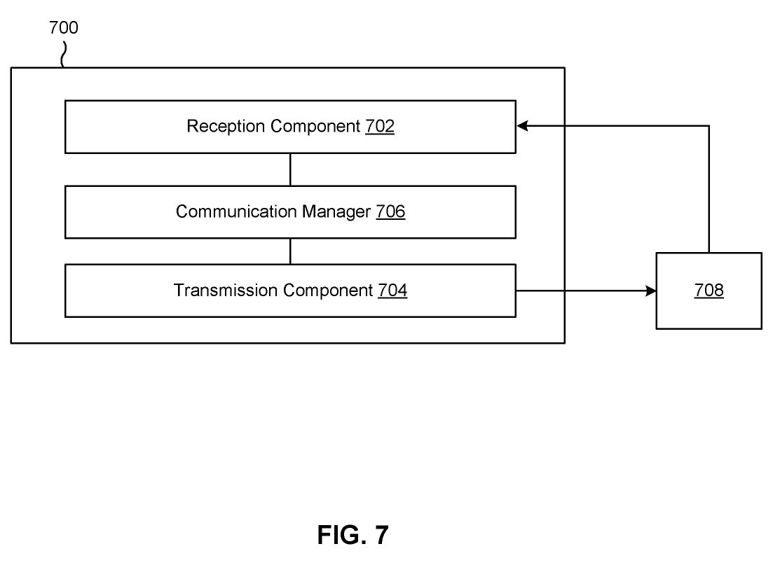

In some aspects, the UE 120 includes means for transmitting, during a registration procedure for establishing access to a RAN, registration information to a network entity, wherein the registration information indicates one or more available computing resources and a computing service state associated with availability for performing one or more computing services; or means for receiving, from the network entity, a computing task request, associated with a computing task, in accordance with the available computing resources and the computing service state. The means for the UE 120 to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

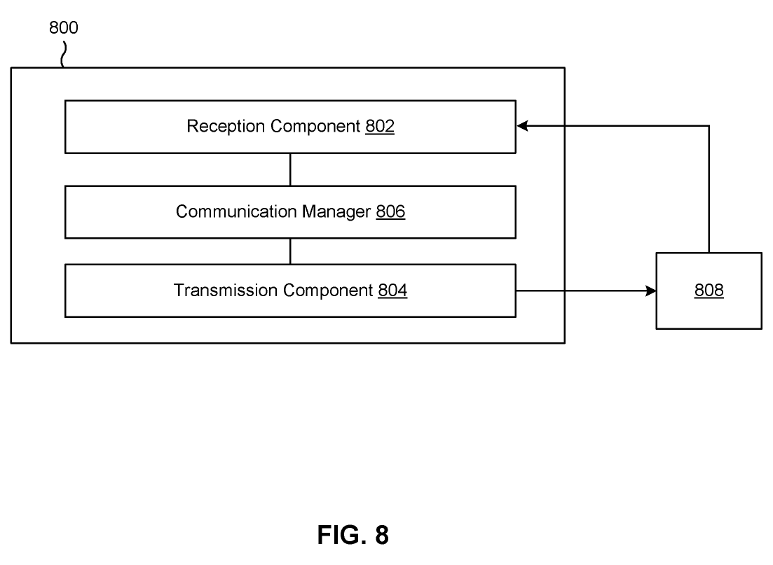

In some aspects, the network node 110 includes means for receiving, during a registration procedure for establishing access to a RAN, registration information output by a UE 120, wherein the registration information indicates one or more available computing resources of the UE 120 and a computing service state associated with availability of the UE 120 to perform one or more computing services; or means for transmitting, to the UE 120, a computing task request, associated with a computing task, in accordance with the available computing resources and the computing service state. The means for the network node 110 to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

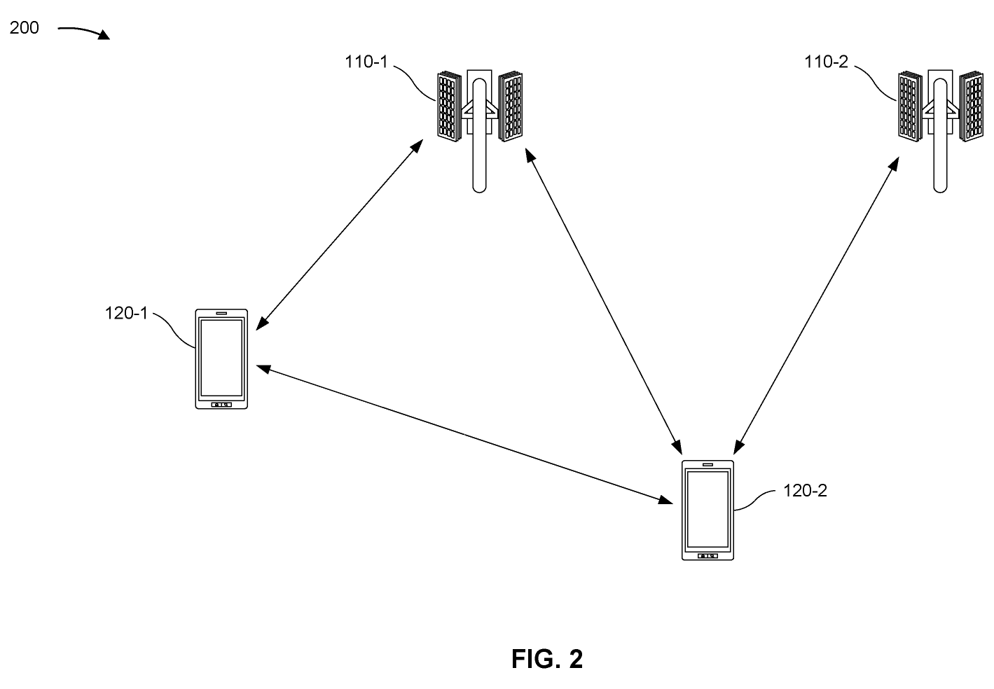

FIG. 2 is a diagram illustrating an example 200 associated with cooperative computing. As shown in FIG. 2, example 200 includes communication between network nodes (e.g., a first network node 110-1 and a second network node 110-2) and UEs (e.g., a first UE 120-1 and a second UE 120-2). In some aspects, the first UE 120-1 may be a cooperative UE, and the second UE 120-2 may be a target UE in a cooperative computing environment. For example, one or more of the first UE 120-1, the second UE 120-2, the first network node 110-1, or the second network node 110-2 may be configured for device cooperation. The device cooperation may be implemented via one or more links between the first UE 120-1 and the second UE 120-2, between the first network node 110-1 and the second network node 110-2, between the first UE 120-1 and the first network node 110-1, between the second UE 120-2 and the first network node 110-1, or between the second UE 120-2 and the second network node 110-2. In some aspects, the example 200 may be implemented in accordance with a generalized multi-TRP (M-TRP) operation, in which one or more of the first UE 120-1 or the second UE 120-2 may operate as a TRP.

In some aspects, the first UE 120-1 may provide computing resources for computationally intensive or memory intensive applications. Examples of computationally intensive or memory intensive applications may include running a large language model, on-device AI/ML training for next sentence prediction, channel state feedback (CSF) computation distribution (e.g., offloading CSF computation from one device to another device). Accordingly, in some aspects, the first UE 120-1 may be configured to allocate a portion of its processor resources or memory resources to support one or more tasks associated with the second UE 120-2 or with another device in the system 200. In some aspects, the first UE 120-1 may be an application server configured to split computing operations for XR or other computational tasks. The second UE 120-2 may communicate with the first UE 120-1 in order to access the distributed computing resources provided by the first UE 120-1. In some aspects, the first UE 120-1 and the second UE 120-2 may communicate via a sidelink protocol. Alternatively, the first UE 120-1 and the second UE 120-2 may communicate via a network node (e.g., via the first network node 110-1).

In some aspects, a network entity (e.g., the first network node 110-1) may be configured to store registration information, which may include information about computing capabilities of the first UE 120-1, as part of a registration process. In some aspects, the first network node 110-1 may record one or more key performance indicators (KPIs) for computing tasks performed by the first UE 120-1. The KPIs may include a percentage of finished computing requests or a percentage of accepted computing requests, among other examples.

In accordance with the KPIs, the network entity can make informed decisions when assigning new computing tasks to UEs, such as preferring a UE that has historically completed a higher percentage of compute requests. Moreover, the UEs within the communication system 200, such as the first UE 120-1 and the second UE 120-2, may have computing-idle and computing-active periods, during which the first UE 120-1 may declare its availability to perform computing tasks for other devices (such as the second UE 120-2) or indicate when it is not available due to local tasks occupying at least some of the computing resources of the first UE 120-1.

In the example 200 of FIG. 2, the first UE 120-1 may perform a RAN-based computing registration. In some aspects, the first UE 120-1 may be configured to register its computing information with a local computing service function (LCSF) through a RAN. The LCSF may be configured to receive computing requests from the first UE 120-1, from the second UE 120-2, or a combination thereof, among other examples. In some aspects, the LCSF may be configured to receive computing requests from the second UE 120-2 via a different RAN (e.g., a RAN other than the RAN serving the first UE 120-1). In some aspects, as a result of receiving computing requests for the second UE 120-2 via the different RAN, the LCSF may be configured to select a UE (e.g., the first UE 120-1) to perform the computing task.

Cooperative device computing, as described herein, may improve network coverage and improve network energy efficiency. For example, as a result of the first UE 120-1 indicating available computing resources and a computing service state as part of a registration process, the first network node 110-1 may determine which UEs are best suited to perform one or more computing tasks. The first network node 110-1 may selectively assign computing tasks to UEs (e.g., the first UE 120-1) that have available computing resources and are operating in a state that allows the UE to complete the computing task.

As indicated above, FIG. 2 is provided as an example. Other examples may differ from what is described with regard to FIG. 2.

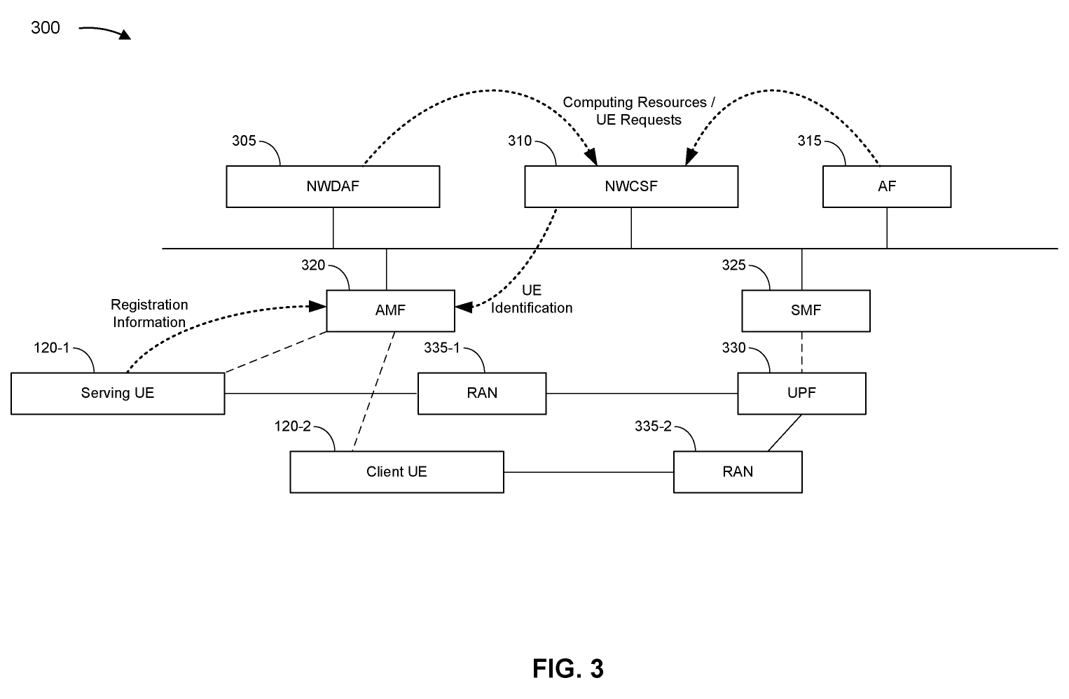

FIG. 3 is a diagram illustrating an example 300 associated with device cooperation for distributed computing. As shown in FIG. 3, example 300 includes communication between multiple network entities such as a network data analytics function (NWDAF) 305, a network computing service function (NWCSF) 310, an application function (AF) 315, an AMF 320, a session management function (SMF) 325, a user plane function (UPF) 330, and one or more RANs 335. The RANs 335, for example, may include a first RAN 335-1 serving a first UE 120-1 (e.g., a serving UE) and a second RAN 335-2 serving a second UE 120-2 (e.g., a client UE).

The NWDAF 305 be configured to collect, store, and analyze network data to provide analytics information to other network entities. The NWCSF 310 may be configured to manage computing resources and computing requests related to one or more of the UEs 120. The AF 315 may be configured to request specific computing services from the NWCSF 310 for one or more of the UEs 120. The AMF 320 may be a core network entity configured to handle UE registration, identification, and mobility management. The SMF 325 may be a core network entity configured to manage UE sessions, including establishing and modifying UE communication sessions. The UPF 330 may be configured to manage data packet processing and forwarding between one or more of the UEs 120 and one or more external data networks. The RANs 335, including the first RAN 335-1 and the second RAN 335-2, may be configured to facilitate wireless communication between one or more UEs 120 and the core network entities.

In some aspects, as part of a registration process, the first UE 120-1 may transmit registration information to the NWCSF 310 through the AMF 320. In some aspects, the registration information may indicate one or more available computing resources and a computing service state associated with the availability of the first UE 120-1 to perform one or more computing services. The registration information may be included in a registration request message or in another message. In some aspects, to indicate its computing resources in the registration information, the first UE 120-1 may transmit information associated with one or more of a floating-point operation capability, a memory capacity, a power supply status, one or more computational architecture parameters, or one or more hardware acceleration capabilities. The one or more architecture parameters may include one or more parameters associated with floating or fixed-point computation, a bit width, or a combination thereof, among other examples. In some aspects, one or more of the architecture parameters indicated via the registration information may be associated with support for one or more convolutional neural networks (CNNs), each having a quantity of layers and input dimensions. In some aspects, one or more of the architecture parameters indicated via the registration information may be associated with support for hardware acceleration for one or more architectures. In some aspects, the first UE 120-1 may indicate mobility information via the registration information. The mobility information may be associated with a geographic area, or a change in geographic area, of the first UE 120-1. In some aspects, the mobility information may be associated with a time frame. For example, the first UE 120-1 may indicate, via the registration information, that the first UE 120-1 will be stationary or mobile within limited area during a first window of time (e.g., 9am to 5pm) and during a second window of time (e.g., overnight). In some aspects, the first UE 120-1 may indicate that it will be mobile while a user is traveling from home to work (e.g., between 8am and 9am) and from work to home (e.g., between 5pm and 6pm).

As discussed below, the network may use the registration information to transmit computing requests containing a computing task to the first UE 120-1. For example, when the network wants to page a non-mobile UE (e.g., the second UE 120-2) operating in an RRC idle state, the network may transmit the paging message through a last network node (e.g., network node 110) that the second UE 120-2 connected to before transitioning to the RRC idle state.

In some aspects, besides the mobility information, other information or indications included in the registration information may be associated with a time frame. Alternatively or in addition, in some aspects, the first UE 120-1 may indicate if the one or more computing resources are associated with a guaranteed service or a best effort service. Computing resources associated with a guaranteed service may always be available for an incoming computing request. Computing resources associated with a best effort service may be available depending on a local computing load of the first UE 120-1. In some aspects, the first UE 120-1 may be configured to indicate or request an incentive or expected compensation for performing the computing task included in the computing request. In some aspects, the incentive or expected compensation may be monetary or associated with an allocation of computing resources or other services to be performed on behalf of the first UE 120-1.

In some aspects, the first UE 120-1 may indicate the computing service state in the registration information. The computing service state may include one or more of a computing-enabled state, a computing-disabled state, a computing-active period, or a computing-idle period. The computing-enabled state may include one or more of a computing-active period or a computing-idle period. When operating in the computing-idle period, the first UE 120-1 may not accept computing requests. In some aspects, the first UE 120-1 may continue to transmit registration information to the network while operating in the computing-idle period. In some aspects, the first UE 120-1 may enter the computing-idle period to save energy.

In some aspects, the computing state of the first UE 120-1 and the RRC state of the first UE 120-1 may be different. For example, the first UE 120-1 may indicate, in the registration information, the computing-enabled state to perform computing services for the second UE 120-2 while the first UE 120-1 is disconnected from the network and operating in an RRC idle state. Alternatively or in addition, the first UE 120-1 may be configured to indicate a computing-disabled state (e.g., where the first UE 120-1 is unable to perform computing services on behalf of the second UE 120-2) in the registration information while the first UE 120-1 is operating in an RRC connected state. Accordingly, the computing-active period and the RRC active state need not overlap, which may improve resource utilization and power consumption for the network, the first UE 120-1, or a combination thereof, among other examples. Alternatively or in addition, the computing-active period and the RRC active state may at least partially overlap. For example, for computing tasks that involve a relatively quick data exchange (e.g., rendering), the first UE 120-1 may perform the computing task while operating in the RRC active state.

While operating in the computing-active period, the first UE 120-1 may accept and perform computing service on behalf of other devices, such as on behalf of the second UE 120-2. When the first UE 120-1 is operating in the computing-idle period, the first UE 120-1 may provide, to the network, a time offset, a duration, or a combination thereof, among other examples, associated with the computing-idle period. In some aspects, the first UE 120-1 may be configured to adjust a configuration for the computing-idle period in accordance with the available computing resources of the first UE 120-1. For example, in some aspects, the first UE 120-1 may declare, through a communication with the network, a computing-idle period during a time frame during which the first UE 120-1 is performing a computing task for a client UE (e.g., the second UE 120-2). Alternatively or in addition, in some aspects, when operating in the computing-idle period, the first UE 120-1 may reject requests to perform computing tasks for other devices. For example, the first UE 120-1 may set the computing-active period to the computing-idle period as a result of the first UE 120-1 performing one or more local computing tasks, making the computing resources of the first UE 120-1 unavailable for cooperative computing. In some aspects, the first UE 120-1 may not monitor for computing requests while the first UE 120-1 is operating in the computing-idle period.

In some aspects, rather than reject all computing requests received while the first UE 120-1 is operating in the computing-idle period, the first UE 120-1 may accept only high-priority tasks, reject only low-priority tasks, or a combination thereof, among other examples. The priority of the computing task included in the computing request may be based on one or more factors such as an identity of the client (e.g., the second UE 120-2) and the incentive for the first UE 120-1 to accept the computing request and perform the computing task. In some aspects, if the first UE 120-1 will not be able to finish the computing task during a computing-active period, the first UE 120-1 may continue to perform the computing task even after the first UE 120-1 has transitioned to a computing-idle period. In some aspects, even when operating in the computing-idle period, the first UE 120-1 may transmit the registration information, including one or more registration information updates, to the network. In some aspects, the first UE 120-1 may receive, from the network, one or more suggested configurations for the computing-active period, the computing-idle period, or a combination thereof, among other examples. The first UE 120-1 may accept and apply one or more of the configurations received from the network.

In some aspects, a network entity (e.g., a network node 110, an AMF, an NWCSF in a core network interacting with the AMF, an NWDAF, an AF, or a combination thereof, among other examples) may select one or more UEs 120 to perform computing tasks. In some aspects, the network entity may select the one or more UEs 120 in accordance with registration information received from each of the UEs 120. In some aspects, the network entity may be configured to record one or more KPIs, associated with the computing tasks, for each UE 120. For example, the network entity may record a percentage of finished computing requests, a percentage of accepted computing requests, or a combination thereof, among other examples, for each UE 120. In some aspects, one or more network entities may share KPIs with one another. Accordingly, KPIs for the first UE 120-1 recorded by one network entity may be shared with another network entity.

In some aspects, when a network entity assigns new computing resources to one or more UEs 120, the network entity may select a UE 120 to perform the computing task in accordance with a capability of the UE 120 to perform the task and based on the KPIs of the UE 120 collected by one or more network entities. Accordingly, if two UEs 120 have similar computing capabilities but one UE 120 has completed 20% of received computing requests while another UE 120 has completed 99% of received computing requests, the network entity may transmit the computing request to the UE 120 with the higher percentage of completed computing requests.

After the computing service has been performed (e.g., after the UE 120 has completed the computing tasks), the network entity may transmit an update to one or more other network entities to update the KPIs associated with the UE 120. For example, the network entity may indicate whether the UE 120 completed the computing service, the latency associated with completing the computing service, or a combination thereof, among other examples, so other network entities may consider using the UE 120 for computing services in the future.

As shown in the example 300 of FIG. 3, the AMF 320 may transmit the registration information received from the first UE 120-1 to the NWCSF 310. The NWCSF 310 may receive computing resource requests or UE computing requests from other network entities such as the AF 315 or the NWDAF 305. For example, in some aspects, the AF 315 may transmit one or more computing resource requests to the NWCSF 310. Alternatively or in addition, the NWDAF 305 may transmit one or more computing resource requests in accordance with network analytics information. In some aspects, the computing resource request may be associated with a computing task to be performed on behalf of the second UE 120-2.

In some aspects, the NWCSF 310 may select an appropriate UE (e.g., the first UE 120-1) to perform the requested computing task. In some aspects, the NWCSF 310 may select the appropriate UE in accordance with the available computing resources indicated in the registration information, in accordance with one or more KPIs associated with the first UE 120-1, or a combination thereof, among other examples. As a result of identifying the first UE 120-1 for the computing task, the NWCSF 310 may transmit a UE identification request to the AMF 320 to locate or identify the first UE 120-1. In accordance with the UE identification request, the AMF 320 may facilitate communication between the NWCSF 310 and the first UE 120-1 through the first RAN 335-1. Alternatively, in some aspects, communication with the first UE 120-1 may be facilitated via the RAN 335 or through other core network entities such as the SMF 325 and UPF 330, depending on the session or data requirements. After the computing service has been completed by the first UE 120-1, the RAN 335 may transmit information indicating the completion status, latency, or other computing KPIs back to the NWCSF 310 through the AMF 320. The NWCSF 310 may update its database with these KPIs to inform future decisions regarding UE computing resource assignments.

In some aspects, the first UE 120-1 may be configured to transmit updated registration information in accordance with one or more changes in the one or more available computing resources or the computing service state. In some aspects, as discussed above, the first UE 120-1 may be configured to set the computing service state to a computing-idle period and transmit a task rejection message for the computing task while operating in the computing-idle period. Alternatively, the first UE 120-1 may be configured to transmit a task acceptance message while operating in a computing-enabled state or the computing-idle period. For example, as discussed above, the first UE 120-1 may transmit the task acceptance message while operating in the computing-idle period as a result of the computing task having a high priority. In some aspects, the first UE 120-1 may transmit the registration information to the network entity by transmitting the registration information to an NWCSF, a RAN, or an LCSF. Alternatively or in addition, the first UE 120-1 may receive the computing request from the NWCSF, the RAN or the LCSF.

In some aspects, the registration information transmitted by the first UE 120-1 may be associated with a registration area. The registration area may be signaled separately from a device tracking area or a RAN-based tracking area. In some aspects, the registration area may be defined as an area associated with a server (e.g., a network entity), such that UEs 120 within that area can register with that server. In some aspects, two or more areas may be separate from one another or may at least partially overlap. In some aspects, one or more of the areas may be separate from, or may at least partially coincide, with other areas associated with data service. For example, one or more areas may be separate from or at least partially coincide with a RAN notification area, a tracking area, or a registration area for data, among other examples. In some aspects, the network entity may signal or otherwise indicate one or more conditions that may enable one or more UEs 120 to register computing resources with a core network or RAN. For example, a device or network may choose a same registration area for computing and tracking for latency sensitive applications. Alternatively or in addition, the device or network may choose a different registration area for computing the tracking considering availability or loading of computing resources in an area. In some aspects, a computing registration area may include a computing resource in the core network (such as a multi-access edge computing (MEC) node) and one or more UEs 120.

In some aspects, the UEs 120 may be configured to transmit updated registration information in accordance with a timer or as a result of detecting a mobility event associated with leaving a registration area. For example, the UEs 120 may be configured to update their computing registration with a network entity as a result of the timer elapsing. Alternatively or in addition, each UE 120 may be configured to update its computing registration with the network entity as a result of the UE 120 moving to a location outside the current computing registration area or as a result of the UE 120 being stationary (e.g., the UE 120 being expected to stay in a same registration area for a time window). In some aspects, a UE 120 may initiate a computing registration update due to mobility as a result of the UE 120 completing a cell reselection process onto a cell that does not belong to a computing registration area specified by the network entity. Alternatively or in addition, one or more of the UEs 120 may be configured to update their registration information in accordance with a change of a computing resource, a computing capability, or a combination thereof, among other examples. To update computing information, the UE 120 may transmit a registration request message to a network entity, and the registration request message may include updated registration information. In some aspects, when operating in a computing-disabled state, a UE 120 may not transmit updated registration information to the network entity. A UE 120 may transmit updated registration information as a result of transitioning from a computing-disabled state to a computing-enabled state (including to a computing-active period or a computing-idle period). In some aspects, the UE 120 may transmit updated registration information as a result of a change in available resources, such as when available memory or a floating point operation fails to satisfy a threshold or value, a change in a mobility state, a change in a power supply state, or a combination thereof, among other examples. In some aspects, a network entity may configure or indicate, to the UE 120, one or more situations in which the UE 120 is expected to transmit updated registration information.

As indicated above, FIG. 3 is provided as an example. Other examples may differ from what is described with regard to FIG. 3.

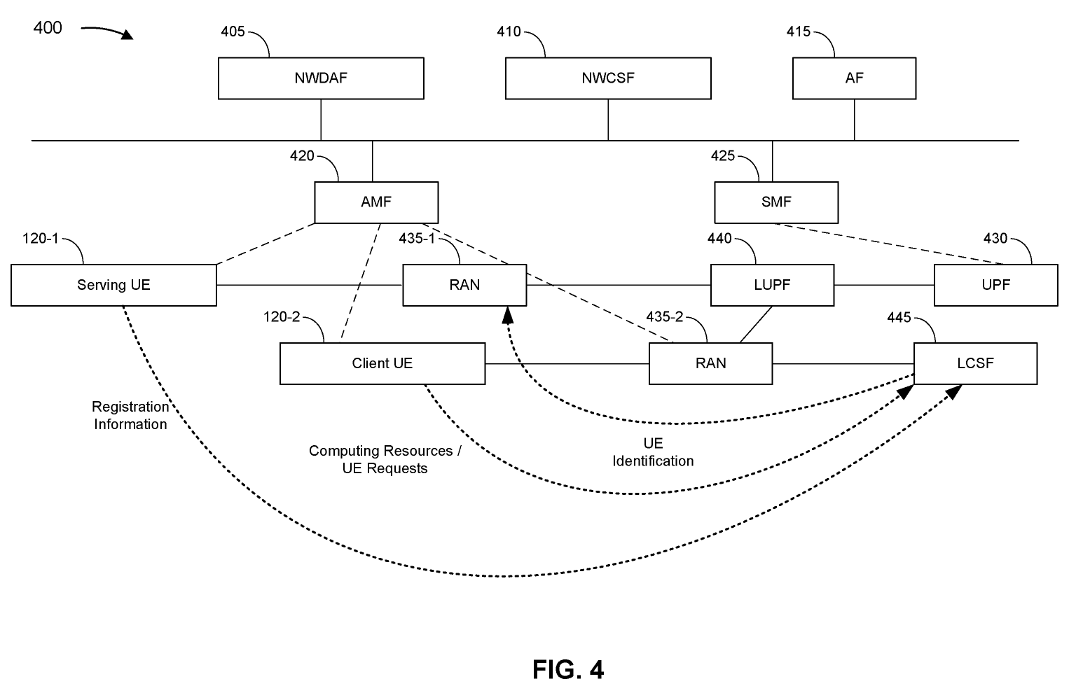

FIG. 4 is a diagram illustrating an example 400 associated with RAN-based UE computing registration. As shown in FIG. 4, example 400 includes communication between multiple network entities such as an NWDAF 405, an NWCSF 410, an AF 415, an AMF 420, an SMF 425, a UPF 430, and one or more RANs 435. The RANs 435, for example, may include a first RAN 435-1 serving a first UE 120-1 (e.g., a serving UE) and a second RAN 435-2 serving a second UE 120-2 (e.g., a client UE). The example 400 may further include a local user plane function (LUPF) 440 and an LCSF 445.

The LUPF 440 may be configured to manage user plane routing within a localized domain associated with one or more RANs. The LUPF 440 may receive user plane data and may process or direct the user plane data in cooperation with other functions such as the UPF 430. The LCSF 445 may be configured to provide computing service handling in a localized environment. In some aspects, the first RAN 435-1 and the second RAN 435-2 may be connected to the LCSF 445 to enable local computing services to be performed. In some aspects, the first UE 120-1 and the second UE 120-2 may be in an area served by the same LCSF 445. The first RAN 435-1 and the second RAN 435-2 may facilitate signaling associated with registration of computing resources, resource requests, and UE identification for computing service management. The LUPF 440 may be configured to route traffic or coordinate data flows for computing tasks managed by the LCSF 445.

In some aspects, the first UE 120-1 may transmit registration information or updated registration information to the LCSF 445. The second UE 120-2 may transmit a computing service request to the LCSF 445 via the second RAN 435-2. The LCSF 445 may select the first UE 120-1 to perform the computing service requested by the second UE 120-2 and direct the computing service request to the first UE 120-1 via the first RAN 435-1 as part of a UE identification notification. The LUPF 440 may handle user plane data routing associated with the computing tasks.

In some aspects, the first UE 120-1 may transmit registration information during initial access or via an RRC reconfiguration message. In some aspects, the example 400 of FIG. 4 may allow the serving UE (e.g., the first UE 120-1) to perform computing tasks on behalf of the client UE (e.g., the second UE 120-2) when both the serving UE and the client UE are expected to stay within an area covered by RANs 435 connected to the same LCSF 445.

As indicated above, FIG. 4 is provided as an example. Other examples may differ from what is described with regard to FIG. 4.

The foregoing examples 300, 400 may be applied to other scenarios. For example, in some aspects, the UEs 120 may be configured to register capabilities for other services such as support for over-the-top (OTT) computing services. An example of performing OTT computing services may occur when a UE is configured to simultaneously communicate via a 3GPP network and a non-3GPP network. The UE may be configured to inform the 3GPP network of its available computing resources in light of how much of the UE’s computing resources are dedicated to the non-3GPP network. In some aspects, the UE may be configured to indicate, to the 3GPP network, that the UE provides limited computing services, provides computing services only for certain client devices, or a combination thereof, among other examples. The computing resources, indicated via the registration information, may be separately indicated for each client. Alternatively or in addition, constraints on one or more subsets of clients that may be simultaneously supported by the UE may also be indicated to the 3GPP network.

FIG. 5 is a diagram illustrating an example process 500 performed, for example, at a UE or an apparatus of a UE. Example process 500 is an example where the apparatus or the UE (e.g., UE 120) performs operations associated with computing resource availability registration for cooperative computing.

As shown in FIG. 5, in some aspects, process 500 may include transmitting, during a registration procedure for establishing access to a RAN, registration information to a network entity, wherein the registration information indicates one or more available computing resources and a computing service state associated with availability for performing one or more computing services (block 510). For example, the UE (e.g., using transmission component 704 or communication manager 706, depicted in FIG. 7) may transmit, during a registration procedure for establishing access to a RAN, registration information to a network entity, wherein the registration information indicates one or more available computing resources and a computing service state associated with availability for performing one or more computing services, as described above.

As further shown in FIG. 5, in some aspects, process 500 may include receiving, from the network entity, a computing task request, associated with a computing task, in accordance with the available computing resources and the computing service state (block 520). For example, the UE (e.g., using reception component 702 or communication manager 706, depicted in FIG. 7) may receive, from the network entity, a computing task request, associated with a computing task, in accordance with the available computing resources and the computing service state, as described above.

Process 500 may include additional aspects, such as any single aspect or any combination of aspects described below or in connection with one or more other processes described elsewhere herein. In a first aspect, the one or more available computing resources are associated with one or more of a floating-point operation capability, a memory capacity, a power supply status, one or more computational architecture parameters, or one or more hardware acceleration capabilities. In a second aspect, alone or in combination with the first aspect, the computing service state is one of a computing-enabled state, a computing-disabled state, a computing-active period, or a computing-idle period. In a third aspect, alone or in combination with one or more of the first and second aspects, the registration information indicates a time frame during which the one or more available computing resources are available. In a fourth aspect, alone or in combination with one or more of the first through third aspects, process 500 includes transmitting updated registration information in accordance with one or more changes in the one or more available computing resources or the computing service state. In a fifth aspect, alone or in combination with one or more of the first through fourth aspects, process 500 includes setting the computing service state to a computing-idle period, and transmitting a task rejection message for the computing task while operating in the computing-idle period. In a sixth aspect, alone or in combination with one or more of the first through fifth aspects, process 500 includes performing at least a portion of the computing task while operating in a computing-idle period. In a seventh aspect, alone or in combination with one or more of the first through sixth aspects, process 500 includes transmitting a task acceptance message while operating in a computing-enabled state or a computing-idle period. In an eighth aspect, alone or in combination with one or more of the first through seventh aspects, transmitting the registration information to the network entity includes transmitting the registration information to an NWCSF, a RAN, or an LCSF. In a ninth aspect, alone or in combination with one or more of the first through eighth aspects, the registration information is associated with a registration area. In a tenth aspect, alone or in combination with one or more of the first through ninth aspects, process 500 includes transmitting updated registration information in accordance with a timer or as a result of detecting a mobility event associated with leaving a registration area. In an eleventh aspect, alone or in combination with one or more of the first through tenth aspects, the registration information includes one of a mobility indication or a stationary indication for a time window. In a twelfth aspect, alone or in combination with one or more of the first through eleventh aspects, the registration information indicates available computing resources for one or more of a guaranteed service or a best-effort service. In a thirteenth aspect, alone or in combination with one or more of the first through twelfth aspects, process 500 includes transmitting an update notification to the network entity, wherein the update notification includes one or more of a completion status or a latency associated with completing the computing task. In a fourteenth aspect, alone or in combination with one or more of the first through thirteenth aspects, receiving the computing task request includes receiving the computing task request from an LCSF via a RAN.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node. Example process 600 is an example where the apparatus or the network node (e.g., network node 110) performs operations associated with computing resource availability registration for cooperative computing.

As shown in FIG. 6, in some aspects, process 600 may include receiving, during a registration procedure for establishing access to a RAN, registration information output by a UE, wherein the registration information indicates one or more available computing resources of the UE and a computing service state associated with availability of the UE to perform one or more computing services (block 610). For example, the network node (e.g., using reception component 802 or communication manager 806, depicted in FIG. 8) may receive, during a registration procedure for establishing access to a RAN, registration information output by a UE, wherein the registration information indicates one or more available computing resources of the UE and a computing service state associated with availability of the UE to perform one or more computing services, as described above.

As further shown in FIG. 6, in some aspects, process 600 may include transmitting, to the UE, a computing task request, associated with a computing task, in accordance with the available computing resources and the computing service state (block 620). For example, the network node (e.g., using transmission component 804 or communication manager 806, depicted in FIG. 8) may transmit, to the UE, a computing task request, associated with a computing task, in accordance with the available computing resources and the computing service state, as described above.

Process 600 may include additional aspects, such as any single aspect or any combination of aspects described below or in connection with one or more other processes described elsewhere herein. In a first aspect, the one or more available computing resources are associated with one or more of a floating-point operations capability, a memory capacity, a power supply status, one or more computational architecture parameters, or one or more hardware acceleration capabilities. In a second aspect, alone or in combination with the first aspect, the computing service state is one of a computing-enabled state, a computing-disabled state, a computing-active period, or a computing-idle period. In a third aspect, alone or in combination with one or more of the first and second aspects, the registration information indicates a time frame during which the one or more available computing resources of the UE are available. In a fourth aspect, alone or in combination with one or more of the first through third aspects, process 600 includes receiving, from the UE, updated registration information in accordance with one or more changes in the one or more available computing resources or the computing service state. In a fifth aspect, alone or in combination with one or more of the first through fourth aspects, process 600 includes receiving a task rejection message for the computing task in accordance with the UE operating in a computing-idle period. In a sixth aspect, alone or in combination with one or more of the first through fifth aspects, process 600 includes receiving a task acceptance message while the UE is operating in a computing-enabled state or a computing-idle period. In a seventh aspect, alone or in combination with one or more of the first through sixth aspects, the registration information is associated with a registration area. In an eighth aspect, alone or in combination with one or more of the first through seventh aspects, process 600 includes receiving updated registration information in accordance with a timer or as a result of detecting a mobility event associated with the UE leaving a registration area. In a ninth aspect, alone or in combination with one or more of the first through eighth aspects, the registration information includes one of a mobility indication or a stationary indication for a time window. In a tenth aspect, alone or in combination with one or more of the first through ninth aspects, the registration information indicates available computing resources of the UE for one or more of a guaranteed service or a best-effort service. In an eleventh aspect, alone or in combination with one or more of the first through tenth aspects, process 600 includes receiving an update notification, wherein the update notification includes one or more of a completion status or a latency associated with completing the computing task.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIGS. 2-4. Additionally, or alternatively, the apparatus 700 may be configured to perform one or more processes described herein, such as process 500 of FIG. 5. In some aspects, the apparatus 700 or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The transmission component 704 may transmit, during a registration procedure for establishing access to a RAN, registration information to a network entity, wherein the registration information indicates one or more available computing resources and a computing service state associated with availability for performing one or more computing services. The reception component 702 may receive, from the network entity, a computing task request, associated with a computing task, in accordance with the available computing resources and the computing service state. The transmission component 704 may transmit updated registration information in accordance with one or more changes in the one or more available computing resources or the computing service state. The communication manager 706 may set the computing service state to a computing-idle period transmitting a task rejection message for the computing task while operating in the computing-idle period. The communication manager 706 may perform at least a portion of the computing task while operating in a computing-idle period. The transmission component 704 may transmit a task acceptance message while operating in a computing-enabled state or a computing-idle period. The transmission component 704 may transmit updated registration information in accordance with a timer or as a result of detecting a mobility event associated with leaving a registration area. The transmission component 704 may transmit an update notification to the network entity, wherein the update notification includes one or more of a completion status or a latency associated with completing the computing task.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a network node, or a network node may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIGS. 2-4. Additionally, or alternatively, the apparatus 800 may be configured to perform one or more processes described herein, such as process 600 of FIG. 6. In some aspects, the apparatus 800 or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 or the transmission component 804 may include or may be included in a network interface. The network interface may be configured to obtain or output signals for the apparatus 800 via one or more communications links, such as a backhaul link, a midhaul link, or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may receive, during a registration procedure for establishing access to a RAN, registration information output by a UE, wherein the registration information indicates one or more available computing resources of the UE and a computing service state associated with availability of the UE to perform one or more computing services. The transmission component 804 may transmit, to the UE, a computing task request, associated with a computing task, in accordance with the available computing resources and the computing service state. The reception component 802 may receive, from the UE, updated registration information in accordance with one or more changes in the one or more available computing resources or the computing service state. The reception component 802 may receive a task rejection message for the computing task in accordance with the UE operating in a computing-idle period. The reception component 802 may receive a task acceptance message while the UE is operating in a computing-enabled state or a computing-idle period. The reception component 802 may receive updated registration information in accordance with a timer or as a result of detecting a mobility event associated with the UE leaving a registration area. The reception component 802 may receive an update notification, wherein the update notification includes one or more of a completion status or a latency associated with completing the computing task.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a UE, comprising: transmitting, during a registration procedure for establishing access to a RAN, registration information to a network entity, wherein the registration information indicates one or more available computing resources and a computing service state associated with availability for performing one or more computing services; and receiving, from the network entity, a computing task request, associated with a computing task, in accordance with the available computing resources and the computing service state.

Aspect 2: The method of Aspect 1, wherein the one or more available computing resources are associated with one or more of a floating-point operation capability, a memory capacity, a power supply status, one or more computational architecture parameters, or one or more hardware acceleration capabilities.

Aspect 3: The method of any of Aspects 1-2, wherein the computing service state is one of a computing-enabled state, a computing-disabled state, a computing-active period, or a computing-idle period.

Aspect 4: The method of any of Aspects 1-3, wherein the registration information indicates a time frame during which the one or more available computing resources are available.

Aspect 5: The method of any of Aspects 1-4, further comprising transmitting updated registration information in accordance with one or more changes in the one or more available computing resources or the computing service state.

Aspect 6: The method of any of Aspects 1-5, further comprising: setting the computing service state to a computing-idle period; and transmitting a task rejection message for the computing task while operating in the computing-idle period.

Aspect 7: The method of any of Aspects 1-6, further comprising performing at least a portion of the computing task while operating in a computing-idle period.

Aspect 8: The method of any of Aspects 1-7, further comprising transmitting a task acceptance message while operating in a computing-enabled state or a computing-idle period.

Aspect 9: The method of any of Aspects 1-8, wherein transmitting the registration information to the network entity includes transmitting the registration information to an NWCSF, a RAN, or an LCSF.

Aspect 10: The method of any of Aspects 1-9, wherein the registration information is associated with a registration area.

Aspect 11: The method of any of Aspects 1-10, further comprising transmitting updated registration information in accordance with a timer or as a result of detecting a mobility event associated with leaving a registration area.

Aspect 12: The method of any of Aspects 1-11, wherein the registration information includes one of a mobility indication or a stationary indication for a time window.

Aspect 13: The method of any of Aspects 1-12, wherein the registration information indicates available computing resources for one or more of a guaranteed service or a best-effort service.

Aspect 14: The method of any of Aspects 1-13, further comprising transmitting an update notification to the network entity, wherein the update notification includes one or more of a completion status or a latency associated with completing the computing task.

Aspect 15: The method of any of Aspects 1-14, wherein receiving the computing task request includes receiving the computing task request from an LCSF via a RAN.

Aspect 16: A method of wireless communication performed by a network node, comprising: receiving, during a registration procedure for establishing access to a RAN, registration information output by a UE, wherein the registration information indicates one or more available computing resources of the UE and a computing service state associated with availability of the UE to perform one or more computing services; and transmitting, to the UE, a computing task request, associated with a computing task, in accordance with the available computing resources and the computing service state.

Aspect 17: The method of Aspect 16, wherein the one or more available computing resources are associated with one or more of a floating-point operations capability, a memory capacity, a power supply status, one or more computational architecture parameters, or one or more hardware acceleration capabilities.

Aspect 18: The method of any of Aspects 16-17, wherein the computing service state is one of a computing-enabled state, a computing-disabled state, a computing-active period, or a computing-idle period.

Aspect 19: The method of any of Aspects 16-18, wherein the registration information indicates a time frame during which the one or more available computing resources of the UE are available.

Aspect 20: The method of any of Aspects 16-19, further comprising receiving, from the UE, updated registration information in accordance with one or more changes in the one or more available computing resources or the computing service state.

Aspect 21: The method of any of Aspects 16-20, further comprising receiving a task rejection message for the computing task in accordance with the UE operating in a computing-idle period.

Aspect 22: The method of any of Aspects 16-21, further comprising receiving a task acceptance message while the UE is operating in a computing-enabled state or a computing-idle period.

Aspect 23: The method of any of Aspects 16-22, wherein the registration information is associated with a registration area.

Aspect 24: The method of any of Aspects 16-23, further comprising receiving updated registration information in accordance with a timer or as a result of detecting a mobility event associated with the UE leaving a registration area.

Aspect 25: The method of any of Aspects 16-24, wherein the registration information includes one of a mobility indication or a stationary indication for a time window.

Aspect 26: The method of any of Aspects 16-25, wherein the registration information indicates available computing resources of the UE for one or more of a guaranteed service or a best-effort service.

Aspect 27: The method of any of Aspects 16-26, further comprising receiving an update notification, wherein the update notification includes one or more of a completion status or a latency associated with completing the computing task.

Aspect 28: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-27.

Aspect 29: An apparatus for wireless communication at a device, the apparatus comprising one or more memories and one or more processors coupled to the one or more memories, the one or more processors configured to cause the device to perform the method of one or more of Aspects 1-27.

Aspect 30: An apparatus for wireless communication, the apparatus comprising at least one means for performing the method of one or more of Aspects 1-27.

Aspect 31: A non-transitory computer-readable medium storing code for wireless communication, the code comprising instructions executable by one or more processors to perform the method of one or more of Aspects 1-27.

Aspect 32: A non-transitory computer-readable medium storing a set of instructions for wireless communication, the set of instructions comprising one or more instructions that, when executed by one or more processors of a device, cause the device to perform the method of one or more of Aspects 1-27.

Aspect 33: A device for wireless communication, the device comprising a processing system that includes one or more processors and one or more memories coupled with the one or more processors, the processing system configured to cause the device to perform the method of one or more of Aspects 1-27.

Aspect 34: An apparatus for wireless communication at a device, the apparatus comprising one or more memories and one or more processors coupled to the one or more memories, the one or more processors individually or collectively configured to cause the device to perform the method of one or more of Aspects 1-27.

Aspect 35: A device comprising a processing system that includes one or more processors and one or more code-storing memories coupled with the one or more processors, the processing system configured to cause the device to perform the method of one or more of Aspects 1-27.

Aspect 36: A device comprising a processing system that includes processor circuitry and code-storing memory circuitry, the processing system configured to cause the device to perform the method of one or more of Aspects 1-27.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
transmit, during a registration procedure for establishing access to a radio access network (RAN), registration information to a network entity, wherein the registration information indicates one or more available computing resources and a computing service state associated with availability for performing one or more computing services; and
receive, from the network entity, a computing task request, associated with a computing task, in accordance with the available computing resources and the computing service state.

2. The UE of claim 1, wherein the one or more available computing resources are associated with one or more of a floating-point operation capability, a memory capacity, a power supply status, one or more computational architecture parameters, or one or more hardware acceleration capabilities.

3. The UE of claim 1, wherein the computing service state is one of a computing-enabled state, a computing-disabled state, a computing-active period, or a computing-idle period.

4. The UE of claim 1, wherein the registration information indicates a time frame during which the one or more available computing resources are available.

5. The UE of claim 1, wherein the processing system is configured to cause the UE to transmit updated registration information in accordance with one or more changes in the one or more available computing resources or the computing service state.

6. The UE of claim 1, wherein the processing system is configured to cause the UE to:
set the computing service state to a computing-idle period; and
transmit a task rejection message for the computing task while operating in the computing-idle period.

7. The UE of claim 1, wherein the processing system is configured to cause the UE to perform at least a portion of the computing task while operating in a computing-idle period.

8. The UE of claim 1, wherein the processing system is configured to cause the UE to transmit a task acceptance message while operating in a computing-enabled state or a computing-idle period.

9. The UE of claim 1, wherein the processing system, to cause the UE to transmit the registration information to the network entity, is configured to cause the UE to transmit the registration information to a network computing service function, a RAN, or a local computing service function.

10. The UE of claim 1, wherein the registration information is associated with a registration area.

11. The UE of claim 1, wherein the processing system is configured to cause the UE to transmit updated registration information in accordance with a timer or as a result of detecting a mobility event associated with leaving a registration area.

12. The UE of claim 1, wherein the registration information includes one of a mobility indication or a stationary indication for a time window.

13. The UE of claim 1, wherein the registration information indicates available computing resources for one or more of a guaranteed service or a best-effort service.

14. The UE of claim 1, wherein the processing system is configured to cause the UE to transmit an update notification to the network entity, wherein the update notification includes one or more of a completion status or a latency associated with completing the computing task.

15. The UE of claim 1, wherein the processing system, to cause the UE to receive the computing task request, is configured to cause the UE to receive the computing task request from a local computing service function via a RAN.

16. The UE of claim 1, wherein the computing task is managed by the network entity.

17. A method of wireless communication performed by a user equipment (UE), comprising:
transmitting, during a registration procedure for establishing access to a RAN, registration information to a network entity, wherein the registration information indicates one or more available computing resources and a computing service state associated with availability for performing one or more computing services; and
receiving, from the network entity, a computing task request, associated with a computing task, in accordance with the available computing resources and the computing service state.

18. The method of claim 17, wherein the one or more available computing resources are associated with one or more of a floating-point operation capability, a memory capacity, a power supply status, one or more computational architecture parameters, or one or more hardware acceleration capabilities.

19. The method of claim 17, wherein the computing service state is one of a computing-enabled state, a computing-disabled state, a computing-active period, or a computing-idle period.

20. A non-transitory computer-readable medium storing a set of instructions for wireless communication, the set of instructions comprising:
one or more instructions that, when executed by one or more processors of a user equipment (UE), cause the UE to:
transmit, during a registration procedure for establishing access to a radio access network (RAN), registration information to a network entity, wherein the registration information indicates one or more available computing resources and a computing service state associated with availability for performing one or more computing services; and
receive, from the network entity, a computing task request, associated with a computing task, in accordance with the available computing resources and the computing service state.
